(19) United States
(12) Patent Application Publication
(10) Pub. No.: US 2007/0103434 A1
(43) Pub. Date: May 10, 2007

(54) PORTABLE COMMUNICATION DEVICE AND POWER SAVING METHOD USED THEREIN

(75) Inventors: Wen-Chuan Lian, Shenzhen (CN); Kuan-Hong Hsieh, Shenzhen (CN); Han-Che Wang, Shenzhen (CN); Hua-Dong Cheng, Shenzhen (CN)

Correspondence Address: NORTH AMERICA INTELLECTUAL PROPERTY CORPORATION, P.O. BOX 506, MERRIFIELD, VA, 22116, US

(73) Assignee: HON HAI PRECISION INDUSTRY CO., LTD., Taipei Hsien (TW)

(21) Appl. No.: 11/309,504

(22) Filed: Aug. 14, 2006

(30) Foreign Application Priority Data
Nov. 10, 2005 (CN) 200510101213.4

(51) Int. Cl. G09G 5/00

(52) U.S. Cl. 345/156; 345/161

(57) ABSTRACT

A portable communication device is provided. The device has a primary display, a secondary display, and a processing unit. The processing unit is programmed for controlling the primary display and the secondary display according to a current state of the device. The processing unit has the primary display in a power off state if the current state is selected from the group consisting of a standby state, an incoming call state, a communication call state, and a dialing state. A related power saving method used therein is also provided.

### TECHNICAL FIELD

The present invention relates to portable communication devices and power saving methods thereof, and particularly to a portable communication device having two displays and power saving method used therein.

### GENERAL BACKGROUND

With the fast development in electronic technologies, many different models of portable communication devices have been introduced in the electronics consumer market, products such as cell phones, personal digital assistants (PDA), etc., readily satisfying a business requirement or a personal convenience requirement. Particularly, cell phones have become ubiquitous in modern society. Cell phones enable individuals to be easily contacted when they are out shopping, commuting, or at any other locations where land line communications are not possible.

One of the greatest limitations regarding the cell phones is their inability to remain powered for extended periods of time. Since cell phones receive power from built-in batteries, power conservation is important for cell phones. The less power the cell phones consume, the longer the cell phone is operable without interruptions.

With respect to the cell phone, display(s) is a relatively larger component thereof. Accordingly, the display of a cell phone consumes relatively more power than other components of the cell phone. Furthermore, the display is required to be kept in a power on state to display real-time information such as time, battery energy level, incoming calls information, etc. As a result, more power consumption is consumed by the display. Therefore, in order to reduce power consumption by the cell phone as a whole, limiting power consumption of the display of a cell phone may be an effective method.

Accordingly, cell phones with two displays are introduced. These cell phones display real-time information on a small display instead of a large display, resulting in less power consumption since the small display needs less power than the large display. However, regarding these cell phones, the large display thereof is also powered on during a communication call, nevertheless, the large display may not be in use by users since the users often do not view the displays during the communication calls. In other words, these cell phones are still not capable of effectively limiting power consumption of the displays thereof.

What is needed, therefore, is a portable communication device with two displays and power saving method used therein, which can relatively effectively manage power consumption of the displays, thereby saving power consumption on the battery of the portable communication device, and thus to extending an operation time of the portable communication device.

### SUMMARY

A portable communication device is provided. The device has a primary display, a secondary display, and a processing unit. The processing unit is programmed for controlling the primary display and the secondary display according to a current state of the device. The processing unit has the primary display in a power off state if the current state is selected from the group of consisting of a standby state, an incoming call state, a dialing state, and a communication call state.

A power saving method used in a portable communication device is also provided, wherein the portable communication device has a primary display and a secondary display. The method includes the steps of: (a) detecting a current state of the portable communication device; and (b) controlling the primary display to be in a power off state, if the current state is selected from the group consisting of a standby state, an incoming call sate, a dialing state, and a communication call state.

Other advantages and novel features will be drawn from the following detailed description with reference to the attached drawing, in which:

### BRIEF DESCRIPTION OF DRAWINGS

FIG. 1 is a schematic diagram of a hardware infrastructure of a portable communication device in accordance with a preferred embodiment of the present invention;

FIG. 2 is a flowchart of a preferred display method used in the portable communication device of FIG. 1; and

FIG. 3 is a flowchart of a preferred method of implementing one step of FIG. 2, namely controlling a primary display and a secondary display of the portable communication device.

### DETAILED DESCRIPTION

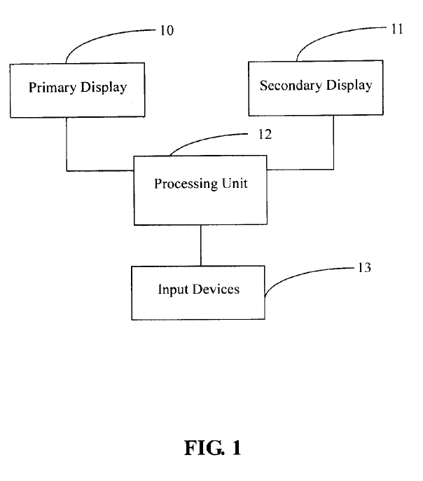

FIG. 1 is a schematic diagram of a hardware infrastructure of a portable communication device in accordance with a preferred embodiment of the present invention. The portable communication device enables users to be contactable while on the move. The portable communication device can be, without limitation, cell phones, personal digital assistants, and/or pagers. While the following discussion is couched in terms of a cell phone, it is equally applicable to other portable communication devices.

The portable communication device, i.e., the cell phone, has a primary display 10, a secondary display 11, a processing unit 12, and a plurality of input devices 13 such as input keys.

The primary display 10 is relatively larger than the secondary display thereby able to display more information. Nevertheless, the primary display 10 consumes more power than the secondary display 11. In other words, the cell phone consumes more power to display information on the primary display 10 than to display information on the secondary display 11.

The input devices 13 are for operational inputs such as, for example answering an incoming call, dialing an outgoing call, editing text messages, viewing text messages, etc.

The cell phone further includes a memory, a transmitter/receiver (transceiver) assembly, an antenna, a data card reader for receiving a data card (e.g., a subscriber identification module (SIM) card, a user identification module (UIM) card), and the like. Since these components are not prime components that consume a significantly large amount of power on a battery of the cell phone, detailed explanations of these components will be omitted.

The processing unit 12 is programmed for controlling the components of the cell phone such as, for example, the primary display 10, the secondary display 11, and the input devices.

The processing unit 12 is capable of controlling the primary display 10 and the secondary display 11 according to a current state of the cell phone. Typically, if there is an incoming call to the cell phone, namely the current state of the cell phone is in an incoming call state, the processing unit 12 displays information of the incoming call on the secondary display 11 and leaves the primary display 10 in a power off state; if the cell phone is communicating with other cell phone(s), namely the current state of the cell phone is in a communication call state, the processing unit 12 still leaves the primary display 10 in the power off state; if there is a dialing operation (including a new dialing operation and a redialing operation) on the cell phone, namely the current state of the cell phone is in a dialing state, the processing unit 12 displays information of an outgoing call on the secondary display 11 and also leaves the primary display 10 in the power off state.

The states described above (i.e., incoming call state, communication call state, and dialing state) constitutes a procedure of call processing. Since a major function of the cell phone revolves around the procedure of call processing, limiting power consumption is most effective by retaining the primary display 10 to be in the power off state during those states.

Additionally, during the procedure of call processing, the processing unit 10 identifies each state based on inputs received by the processing unit 10. For example, if the transmitter/receiver is receiving an incoming call to the cell phone, the processing unit 12 regards the current state of the cell phone as in the incoming call state; if receiving an operational input of answering the incoming call, the processing unit 12 regards the current state of the cell phone as in the communication call state; if receiving operational inputs of dialing an outgoing call, the processing unit 12 regards the current state of the cell phone as in the dialing state.

Furthermore, if receiving operational inputs for information operations such as, for example, editing text messages, viewing text messages, etc., the processing unit 12 regards the current state of the cell phone as in an information processing state. Consequently, an information display operation is required on the primary display 10, that is, the processing unit 12 controls the primary display 10 to be in a power on state to display information in response to the operational inputs for information operations.

In addition, in each state, the processing unit 12 further displays system information (e.g., time, battery energy level, etc.,) on the secondary display 11.

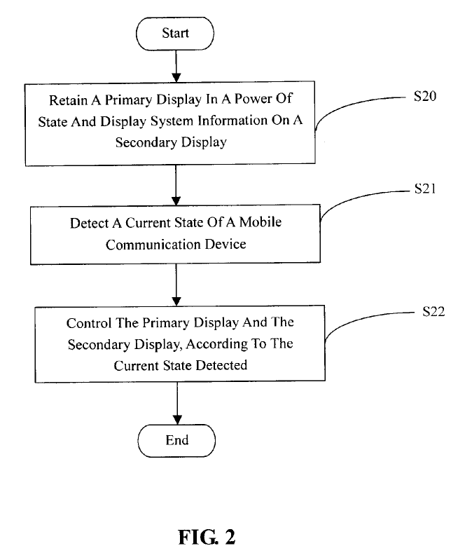

FIG. 2 is a flowchart of a preferred display method used in the portable communication device of FIG. 1. In step S20, namely the cell phone in a standby state, the processing unit 12 controls the primary display 10 to be in the power off state and displays system information, namely real-time information, on the secondary display 11. In step S21, the processing unit 12 detects the current state of the cell phone in real-time. In step S22, the processing unit 12 controls the primary display 10 and the secondary display 11 according to the current state of the cell phone detected. That is, the processing unit 12 retains the primary display 10 in the power off state if the current state of the cell phone is in the procedure of call processing or the standby state, otherwise, the processing unit 12 controls the primary display 10 to be in the power on state for displaying information. Simultaneously, the processing unit 12 displays corresponding real-time information on the secondary display 11 according to the current state of the cell phone detected. For example, in the incoming call state or the dialing call state of the cell phone, the processing unit 12 displays information of the incoming call or the outgoing call on the secondary display 11, otherwise, the processing unit 12 displays the system information on the secondary display 11.

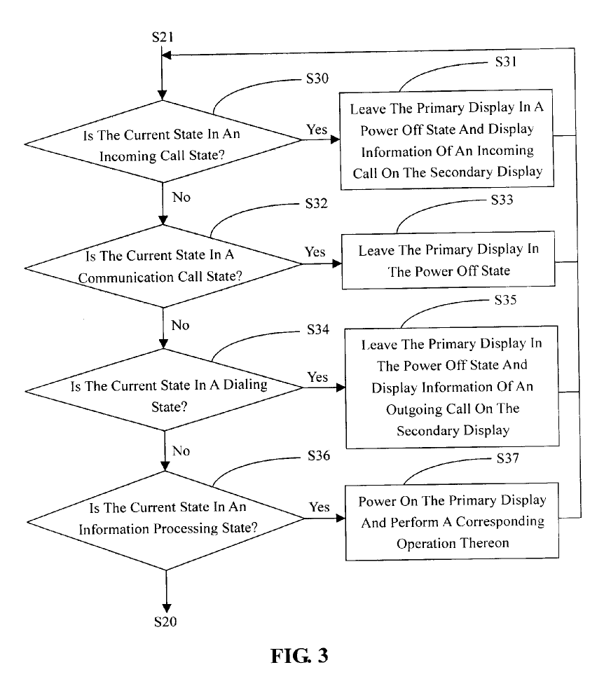

FIG. 3 is a flowchart of a preferred method of implementing step S22 of FIG. 2. In step S30, the processing unit 12 detects whether the current state of the cell phone is in the incoming call state, that is, the processing unit 12 detects whether the cell phone receives the incoming call.

If the current state of the cell phone is in the incoming call state, in step S31, the processing unit 12 retains the primary display 10 to be in the power off state and displays the information of the incoming call on the secondary display 11, and the procedure returns to step S21.

If the current state of the cell phone is not in the incoming call state, in step S32, the processing unit 12 detects whether the current state of the cell phone is in the communication call state, that is, the processing unit 12 detects whether the cell phone receives the operational input of answering the incoming call.

If the current state of the cell phone is the communication call state, in step S33, the processing unit 12 retains the primary display 10 to be in the power off state and continues to display the system information on the secondary display 11, and the procedure returns to step S21.

If the current state of the cell phone is not in the communication call state, in step S34, the processing unit 12 detects whether the current state of the cell phone is in the dialing state, that is, the processing unit 12 detects whether the cell phone receives operational inputs of dialing an outgoing call.

If the current state of the cell phone is in the dialing state, in step S35, the processing unit 12 retains the primary display 10 to be in the power off state and displays the information of the outgoing call on the secondary display 11, and the procedure returns to step S21.

If the current state of the cell phone is not in the dialing state, in step S36, the processing unit 12 detects whether the current state of the cell phone is in the information processing state, that is, the processing unit 12 detects whether the cell phone receives operational inputs for information operations.

If the current state of the cell phone is in the information processing state, in step S37, the processing unit 12 controls the primary display 10 to be in the power on state to display information in response to the operational inputs for information operations and continues to display the system information on the secondary display 11, and the procedure returns to step S21.

If the current state of the cell phone is not in the information processing state, that is, the processing unit 12 does not receive any inputs, and the cell phone is in the standby state, thereupon the procedure returns to step S20.

Accordingly, in one aspect, the present invention relates to software stored on a computer readable medium for saving power of a portable communication device, wherein the portable communication device has a primary display and a secondary display, to perform functions including: (a) detecting a current state of the portable communication device; (b) retaining the primary display in a power off state, if the current state of a portable communication device is either in a standby state, an incoming call state, a dialing state, and a communication call state, otherwise, powering on the primary display to display information; (c) displaying information of an incoming call on the secondary display if the current state of a portable communication device is in the incoming call state; and (d) displaying information of an outgoing call on the secondary display if the current state of a portable communication device is in the dialing state. The software can be stored on a computer readable medium and read by a controller or processing unit 12 to perform corresponding functions.

Although the present invention has been specifically described on the basis of a preferred embodiment and preferred method thereof, the invention is not to be construed as being limited thereto. Various changes or modifications may be made to the embodiment and method without departing from the scope and spirit of the invention.

What is claimed is:

1. A portable communication device comprising:
a primary display;
a secondary display; and
a processing unit configured for controlling the primary display and the secondary display according to a current state of the portable communication device, wherein the processing unit controls the primary display to be in a power off state if the current state of the portable communication device is selected from the group consisting of a standby state, an incoming call state, a dialing state, and a communication call state, thereby reducing power consumption.

2. The portable communication device according to claim 1, wherein the processing unit further displays information of an incoming call on the secondary display, if the current state of the portable communication device is in the incoming call state.

3. The portable communication device according to claim 1, wherein the processing unit further displays information of an outgoing call on the secondary display, if the current state of the portable communication device is in the dialing state.

4. The portable communication device according to claim 1, wherein the processing unit powers on the primary display to display information if the current state of the portable communication device is not selected from the group consisting of the standby state, the incoming call state, the dialing state, and the communication call state.

5. A power saving method used in a portable communication device, wherein the portable communication device has a primary display and a secondary display, the method comprising the steps of:
detecting a current state of the portable communication device; and
controlling the primary display to in a power off state, if the current state of the portable communication device is selected from the group consisting of a standby state, an incoming call state, a dialing state, and a communication call state.

6. The power saving method according to claim 5, further comprising the steps of:
displaying information of an incoming call on the secondary display, if the current state of the portable communication device is in the incoming call state; and
displaying information of an outgoing call on the secondary display, if the current state of the portable communication device is in the dialing state.

7. The power saving method according to claim 5, further comprising the step of:
powering on the primary display to display information if the current state of the portable communication device is not selected from the group consisting of the standby state, the incoming call state, the dialing state, and the communication call state.

8. A power saving method used in a portable communication device, wherein the portable communication device has a primary display and a secondary display, the method comprising the steps of:
detecting a current state of the portable communication device;
controlling power consumption of the primary display and the second display according to the current state of the portable communication device detected.

9. The power saving method according to claim 8, wherein the controlling step further comprises the steps of:
controlling the primary display to be in a power off state if the current state is selected from the group consisting of a standby state, an incoming call state, a dialing state, and a communication call state, otherwise, powering on the primary display to display information; and
controlling the secondary display to be in a power on state regardless of the current state the portable communication device is in.

10. Software stored on a computer readable medium for saving power of a portable communication device, wherein the portable communication device has a primary display and a secondary display, to perform functions comprising:
detecting a current state of the portable communication device; and
controlling the primary display to in a power off state, if the current state is selected from the group consisting of a standby state, an incoming call state, a dialing state, and a communication call state, otherwise, powering on the primary display to display information.

11. The software according to claim 10, further comprising the functions of:
displaying information of an incoming call on the secondary display, if the current state of the portable communication device is in the incoming call state; and
displaying information of an outgoing call on the secondary display, if the current state of the portable communication device is in the dialing state.
